(19) United States
(12) Patent Application Publication
(10) Pub. No.: US 2025/0104267 A1
(43) Pub. Date: Mar. 27, 2025

(54) LOADED ATTITUDE STATE DETECTING DEVICE

(71) Applicants: KABUSHIKI KAISHA TOYOTA JIDOSHOKKI, Kariya-shi (JP); NATIONAL INSTITUTE OF ADVANCED INDUSTRIAL SCIENCE AND TECHNOLOGY, Tokyo (JP)

(72) Inventors: Shinichi MAE, Tsukuba-shi (JP); Yukikazu KOIDE, Tsukuba-shi (JP); Hirokatsu KATAOKA, Tsukuba-shi (JP)

(73) Assignees: KABUSHIKI KAISHA TOYOTA JIDOSHOKKI, Kariya-shi (JP); NATIONAL INSTITUTE OF ADVANCED INDUSTRIAL SCIENCE AND TECHNOLOGY, Tokyo (JP)

(21) Appl. No.: 18/889,764

(22) Filed: Sep. 19, 2024

(30) Foreign Application Priority Data
Sep. 22, 2023 (JP) 2023-158410

(51) Int. Cl. G06T 7/70; B66F 9/075

(52) U.S. Cl. CPC G06T 7/70; B66F 9/0755; G06T 2207/20081

(57) ABSTRACT

A loaded attitude state detecting device is configured to detect loaded attitude states of pallets and cargos when a forklift performs loading/unloading of at least one stage of the pallets with cargos placed thereon, and includes: a detecting unit configured to acquire loaded attitude detection data of the pallets and the cargos by detecting loaded attitudes of the pallets and the cargos; an area extracting unit configured to extract areas of the pallets and the cargos in the loaded attitude detection data acquired by the detecting unit; and a protrusion determining unit configured to determine whether or not a cargo disposed on a holding target pallet held by the forklift or another pallet protrudes from the holding target pallet by a prescribed amount or more in a lateral direction based on the areas of the pallets and the cargos.

### CROSS-REFERENCE TO RELATED APPLICATIONS

This application is based upon and claims the benefit of priority from Japanese Patent Application No. 2023-158410, filed on Sep. 22, 2023, the entire contents of which are incorporated herein by reference.

### TECHNICAL FIELD

The present invention relates to a loaded attitude state detecting device.

### BACKGROUND

For example, Japanese Unexamined Patent Publication No. 2021-62964 describes a technique that an autonomously traveling forklift including a sensor and a camera mounted thereon unloads goods loaded on a truck, and places goods on an autonomously traveling automated guided vehicle.

### SUMMARY

Meanwhile, at an actual distribution site, when loading states (loaded attitude states) of pallets and cargos are abnormal by cargos greatly protruding from pallets, for example, due to vibration or the like during transportation, unloading cannot be performed by stationary loading/unloading control. Hence, it is necessary to detect whether or not the loaded attitude states of the pallets and the cargos are abnormal, and perform appropriate handling matching the loaded attitude states when the loaded attitude states are abnormal.

An object of the present invention is to provide a loaded attitude state detecting device that can detect whether or not loaded attitude states of pallets and cargos are abnormal.

(1) One aspect of the present invention is a loaded attitude state detecting device configured to detect loaded attitude states of pallets and cargos when a forklift performs loading/unloading of at least one stage of the pallets with cargos placed thereon, the loaded attitude state detecting device including: a detecting unit configured to acquire loaded attitude detection data of the pallets and the cargos by detecting loaded attitudes of the pallets and the cargos; an area extracting unit configured to extract areas of the pallets and the cargos in the loaded attitude detection data acquired by the detecting unit; and a protrusion determining unit configured to determine whether or not a cargo disposed on a holding target pallet held by the forklift or another pallet protrudes from the holding target pallet by a prescribed amount or more in a lateral direction based on the areas of the pallets and the cargos.

This loaded attitude state detecting device extracts the areas of the pallets and the cargos in the loaded attitude detection data acquired by detecting the loaded attitudes of the pallets and the cargos. Further, based on the areas of the pallets and the cargos in the loaded attitude detection data, it is determined whether or not the cargo disposed on the holding target pallet held by the forklift or the other pallet protrudes from the holding target pallet by the prescribed amount or more in the lateral direction. When it is determined that the cargo disposed on the holding target pallet or the other pallet protrudes from the holding target pallet by the prescribed amount or more in the lateral direction, it is detected that the loaded attitude states of the pallets and the cargos are abnormal. Consequently, it is possible to detect whether or not the loaded attitude states of the pallets and the cargos are abnormal.

(2) In above (1), the area extracting unit may extract front areas of the pallets and the cargos in the loaded attitude detection data.

According to this configuration, the influence of the shadow or the like of lateral areas of the pallets and the cargos on the protrusion determination of the cargos and the pallets in the loaded attitude detection data is suppressed. Consequently, it is accurately determined whether or not the cargo disposed on the holding target pallet or the other pallet protrudes from the holding target pallet by the prescribed amount or more in the lateral direction.

(3) In above (1) or (2), the protrusion determining unit may determine whether or not the cargo or the other pallet protrudes from the holding target pallet by the prescribed amount or more in the lateral direction by creating a cargo set indicating an area including the pallets and the cargos in contact with each other in an upper-lower direction in the loaded attitude detection data, and determining whether or not a protrusion amount of the cargo or the other pallet with respect to an inner area of two virtual lines formed by extending in the upper-lower direction left and right ends of the holding target pallet in the cargo set is a predetermined threshold or more.

According to this configuration, whether or not the cargo and the pallet protrude is determined per cargo set indicating the area including the pallets and the cargos in contact with each other in the upper-lower direction in the loaded attitude detection data. The cargo set corresponds to a unit of loading/unloading collectively performed by a forklift. Consequently, it is possible to efficiently determine whether or not the cargo and the pallet protrude in units of loading/unloading. Furthermore, by setting the inner area of the two virtual lines formed by extending in the upper-lower direction left and right ends of the holding target pallet in the cargo set, it is possible to easily determine whether or not the cargo or the other pallet protrudes from the holding target pallet by the prescribed amount or more in the lateral direction.

(4) In any one of above (1) to (3), the detecting unit may acquire the loaded attitude image data of the pallets and the cargos as the loaded attitude detection data by imaging the loaded attitude states of the pallets and the cargos, and the area extracting unit may extract the areas of the pallets and the cargos in the loaded attitude image data in units of pixels of the loaded attitude image data.

According to this configuration, it is possible to accurately extract the areas of the pallets and the cargos in the loaded attitude detection data by extracting the areas of the pallets and the cargos in units of pixels of the loaded attitude image data.

(5) In above (4), the area extracting unit may extract the areas of the pallets and the cargos in the loaded attitude image data by using learned data including loaded attitude images of a plurality of types of pallets and cargos and pixel information of the plurality of types of the pallets and the cargos.

According to this configuration, it is possible to accurately extract the areas of the pallets and the cargos in the loaded attitude image data by using the learned data including the loaded attitude image and the pixel information.

(6) In above (5), the learned data may be generated by performing transfer learning on data obtained by annotating the pixel information of the pallets and the cargos to the loaded attitude images of the pallets and the cargos using pre-learning data obtained by pre-learning a formula driven database.

According to this configuration, by using the pre-learning data obtained by pre-learning the formula driven database, it is possible to accurately extract the areas of the pallets and the cargos in the loaded attitude image data while reducing the number of loaded attitude images obtained by imaging the loaded attitudes of the pallets and the cargos.

According to the present invention, it is possible to detect whether or not the loaded attitude states of the pallets and the cargos are abnormal.

### BRIEF DESCRIPTION OF THE DRAWINGS

FIG. 1 is a block diagram illustrating a configuration of a loading/unloading controlling device including a loaded attitude state detecting device according to an embodiment of the present invention;

FIG. 2 is a side view of a forklift on which the loading/unloading controlling device illustrated in FIG. 1 is mounted;

FIG. 3 is a plan view illustrating a state where pallets with cargos placed thereon are loaded on a bed of a truck;

FIGS. 4A and 4B are front views illustrating a state where a pallet interferes with an adjacent pallet and a state where a cargo interferes with an adjacent cargo or pallet;

FIG. 5 is a front view illustrating a state where a cargo placed on a pallet protrudes from the pallet and a state where an upper pallet protrudes from a lower pallet;

FIG. 6 is a block diagram illustrating a function of an area extracting unit illustrated in FIG. 1;

FIGS. 7A and 7B are block diagrams illustrating a function of creating learned data illustrated in FIG. 6;

FIG. 8 is a flowchart illustrating a procedure of pallet interference determination processing executed by a pallet interference determining unit illustrated in FIG. 1;

FIGS. 9A to 9C are front views illustrating a state where the pallet interference determining unit illustrated in FIG. 1 determines whether or not a pallet causes an interference;

FIG. 10 is a flowchart illustrating a procedure of cargo interference determination processing executed by a cargo interference determining unit illustrated in FIG. 1;

FIGS. 11A to 11D are front views illustrating a state where the cargo interference determining unit illustrated in FIG. 1 determines whether or not a cargo causes an interference;

FIG. 12 is a flowchart illustrating a procedure of protrusion determination processing executed by a protrusion determining unit illustrated in FIG. 1; and

FIGS. 13A to 13D are front views illustrating a state where the protrusion determining unit illustrated in FIG. 1 determines whether or not a cargo or a pallet protrudes.

### DETAILED DESCRIPTION

An embodiment of the present invention will be described in detail below with reference to the drawings. In the drawings, the same or equivalent components will be assigned the same reference numerals, and redundant description will be omitted.

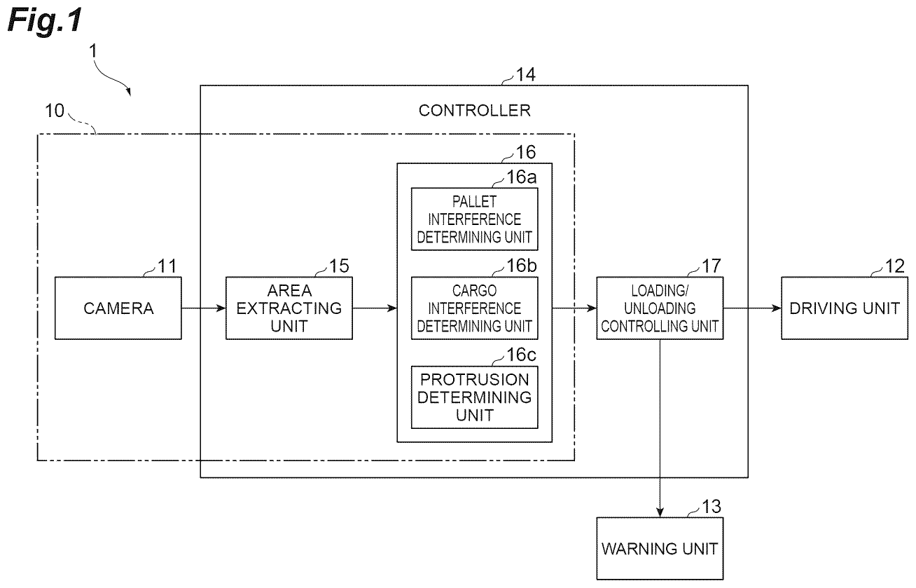

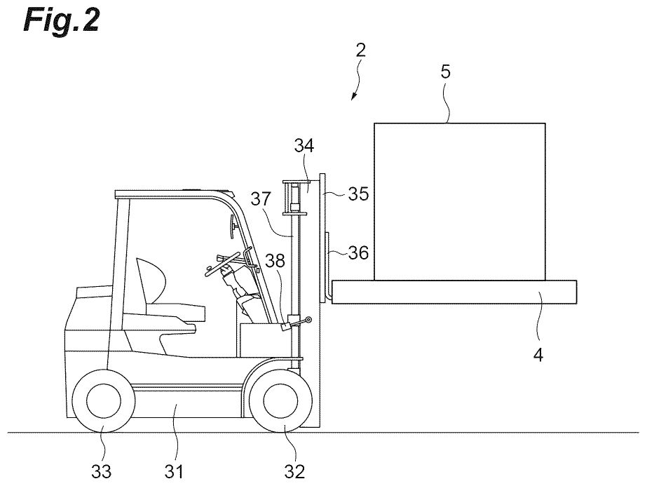

FIG. 1 is a block diagram illustrating a configuration of a loading/unloading controlling device including a loaded attitude state detecting device according to an embodiment of the present invention. In FIG. 1, a loading/unloading controlling device 1 is mounted on a forklift 2 as illustrated in FIG. 2. The forklift 2 is, for example, a counter type forklift.

The forklift 2 includes a vehicle body 31, front wheels 32 that are a pair of right and left drive wheels disposed at a front portion of the vehicle body 31, rear wheels 33 that are a pair of right and left steering wheels disposed at a rear portion of the vehicle body 31, a mast 34 attached to a front end portion of the vehicle body 31, a pair of right and left forks 36 that are attached to the mast 34 so as to be movable up and down via a lift bracket 35, a lift cylinder 37 that moves up and down the forks 36 via the lift bracket 35, and a tilt cylinder 38 that tilts the mast 34.

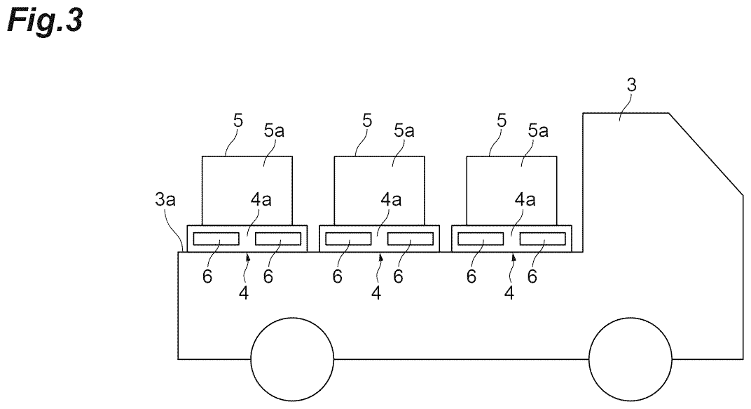

The loading/unloading controlling device 1 is a device that performs loading/unloading control when the forklift 2 automatically performs loading/unloading. Here, as illustrated in FIG. 3, the loading/unloading controlling device 1 controls the forklift 2 at the time when the forks 36 of the forklift 2 hold, that is, unloads a pallet 4 loaded on a bed 3a of a truck 3.

The pallet 4 is, for example, a flat pallet made of plastic or wood. The pallet 4 has a square shape or a substantially square shape in planar view. A cargo 5 is placed on the pallet 4. The pallet 4 is provided with two fork holes 6 into which the forks 36 are inserted. The fork holes 6 extend from a front surface (front) 4a to a rear side of the pallet 4.

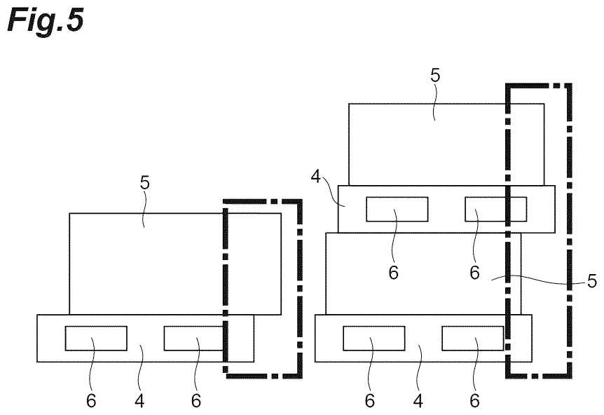

The plurality of pallets 4 are loaded on the bed 3a of the truck 3 along a front-rear direction of the truck 3. The pallets 4 are disposed such that the front surfaces 4a face sideward of the truck 3. Hence, the forklift 2 performs unloading on the side of the truck 3. At this time, the plurality of pallets 4 are aligned and disposed in a lateral direction (left-right direction) seen from the forklift 2. The forklift 2 performs loading/unloading of one or a plurality of upper and lower stages of the pallets 4 with the cargos 5 placed thereon (see FIG. 5 and the like). For example, in a case where the forklift 2 performs unloading of the pallets 4 of the two upper and lower stages, the forks 36 are inserted into the fork holes 6 of the lower pallet 4.

Meanwhile, as illustrated in FIG. 3, in a case where loaded attitude states of the pallets 4 and the cargos 5 are normal, the forklift 2 can smoothly perform unloading. The loaded attitude refers to how the pallet 4 and the cargo 5 are placed.

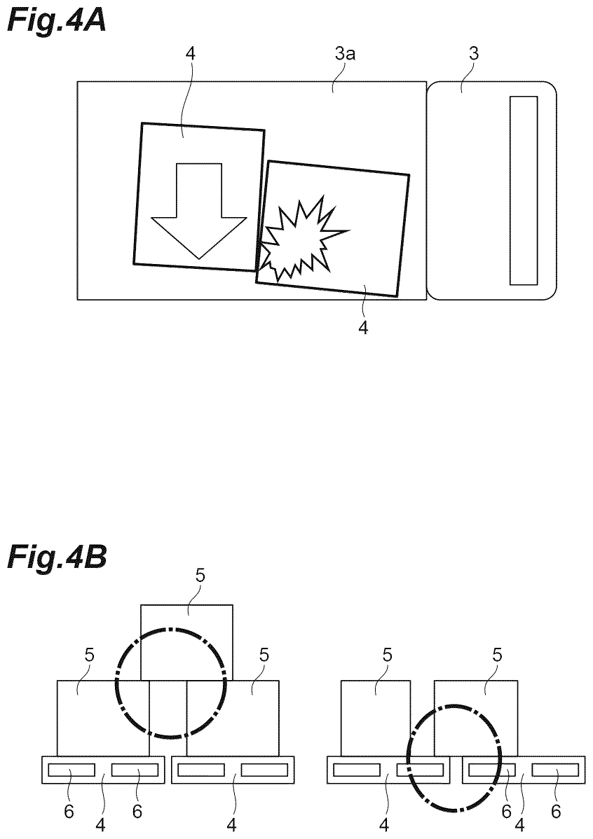

However, as illustrated in FIGS. 4A and 4B, in a case where the loaded attitude states of the pallets 4 and the cargos 5 are abnormal, the forklift 2 may not be able to perform unloading. In a case where, for example, the pallets 4 neighboring in the lateral direction interfere with each other in a width direction of the truck 3 (a direction to draw the pallets 4 from the bed 3a to the side of the truck 3) as illustrated in FIG. 4A, cargo collapse may occur when unloading is performed.

Furthermore, in a case where the cargo 5 placed on the pallet 4 interferes with the cargo 5 placed on the pallet 4 neighboring in the lateral direction, or the cargo 5 placed on the pallet 4 interferes with the pallet 4 neighboring in the lateral direction as illustrated in FIG. 4B, the cargo collapse may also occur when unloading is performed.

Furthermore, as illustrated in FIG. 5, due to vibration or the like during transportation by the truck 3, the cargo 5 may greatly protrude from the pallet 4 in the lateral direction, or the upper pallet 4 may greatly protrude from the lower pallet 4 in the lateral direction. Also in this case, there is a possibility that cargo collapse may occur when unloading is performed.

To solve such a problem, the loading/unloading controlling device 1 detects whether or not the loaded attitude states of the pallets 4 and the cargos 5 are abnormal, and performs appropriate control matching the loaded attitude states when the loaded attitude states of the pallets 4 and the cargos 5 are abnormal.

Therefore, the loading/unloading controlling device 1 includes a loaded attitude state detecting device 10 that detects the loaded attitude states of the pallets 4 and the cargos 5. The loaded attitude state detecting device 10 is a device that detects whether the loaded attitude states of the pallets 4 and the cargos 5 are normal or abnormal when the forklift 2 performs loading/unloading of at least one stage of the pallets 4 in a state where the cargos 5 are placed on the plurality of pallets 4 aligned and disposed in the lateral direction seen from the forklift 2.

The loading/unloading controlling device 1 including the loaded attitude state detecting device 10 includes a camera 11, a driving unit 12, a warning unit 13, and a controller 14.

The camera 11 is an imaging unit that images the front of the forklift 2. The camera 11 acquires loaded attitude image data of the pallets 4 and the cargos 5 by imaging the loaded attitudes of the pallets 4 and the cargos 5. The camera 11 configures a detecting unit that acquires the loaded attitude image data that is the loaded attitude detection data of the pallets 4 and the cargos 5 by detecting the loaded attitudes of the pallets 4 and the cargos 5.

The driving unit 12 includes the above lift cylinder 37, the tilt cylinder 38, a traveling motor (not illustrated) that rotates the front wheels 32 of the forklift 2, and a steering motor (not illustrated) that steers the rear wheels 33 of the forklift 2. The warning unit 13 issues a warning, for example, by generating a warning sound.

The controller 14 includes a CPU, a RAM, a ROM, an input/output interface, and the like. The controller 14 includes an area extracting unit 15, a loaded attitude abnormality determining unit 16, and a loading/unloading controlling unit 17. The camera 11, the area extracting unit 15, and the loaded attitude abnormality determining unit 16 configure the loaded attitude state detecting device 10 according to the present embodiment.

The area extracting unit 15 extracts areas of the pallets 4 and the cargos 5 in the loaded attitude image data acquired by the camera 11. The area extracting unit 15 extracts the areas of the pallets 4 and the cargos 5 in the loaded attitude image data in units of pixels of the loaded attitude image data.

The area extracting unit 15 extracts the areas of the front surface 4a of the pallet 4 and a front surface 5a of the cargo 5 (see FIG. 3) in the loaded attitude image data. The front surface 4a of the pallet 4 and the front surface 5a of the cargo 5 are surfaces facing the forklift 2 performing unloading. The areas of the front surface 4a of the pallet 4 and the front surface 5a of the cargo 5 correspond to front areas of the pallet 4 and the cargo 5.

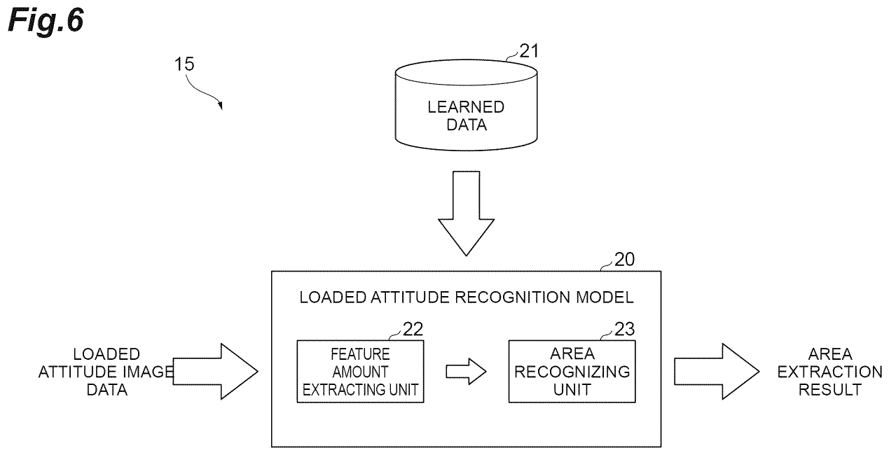

More specifically, as illustrated in FIG. 6, the area extracting unit includes functions including a loaded attitude recognition model 20 and learned data 21. The area extracting unit 15 extracts the areas of the front surface 4a of the pallet 4 and the front surface 5a of the cargo 5 in the loaded attitude image data acquired by the camera 11 by causing the loaded attitude recognition model 20 to read the learned data 21.

The loaded attitude recognition model 20 is an instance segmentation model constructed using deep learning. Instance segmentation is a technique of estimating an individual object position in units of pixels, and performs learning by labeling a target object area in detail and estimates an object position. The loaded attitude recognition model 20 is constructed using data obtained by annotating (assigning) the front areas of the pallets 4 and the cargos 5 to images obtained by photographing the pallets 4 and the cargos 5.

The loaded attitude recognition model 20 includes a feature amount extracting unit 22 that extracts a feature amount of the loaded attitude image acquired by the camera 11 using the learned data 21, and an area recognizing unit 23 that recognizes the areas of the front surface 4a of the pallet 4 and the front surface 5a of the cargo 5 in the loaded attitude image data using the learned data 21 and the feature amount of the loaded attitude image.

The learned data 21 includes two types of data such as loaded attitude images obtained by photographing the pallets 4 and the cargos 5, and data files including information of the pallets 4 and the cargos 5 in the loaded attitude images. The information on the pallets 4 and the cargos 5 in the loaded attitude image includes pixel numbers of the loaded attitude image. The areas of the front surface 4a of the pallet 4 and the front surface 5a of the cargo 5 in the loaded attitude image are indicated by the pixel numbers of the loaded attitude image.

In a case where, for example, the number of types of the cargo 5 is two types of a cardboard box and a component box, and the number of types of the pallet 4 is two types of a plastic pallet and a post pallet, the learned data 21 obtained by assigning labels of the areas of the front surface 4a of the pallet 4 and the front surface 5a of the cargo 5 to the four types of loaded attitude images in total obtained by photographing the pallets 4 and the cargos 5 is prepared.

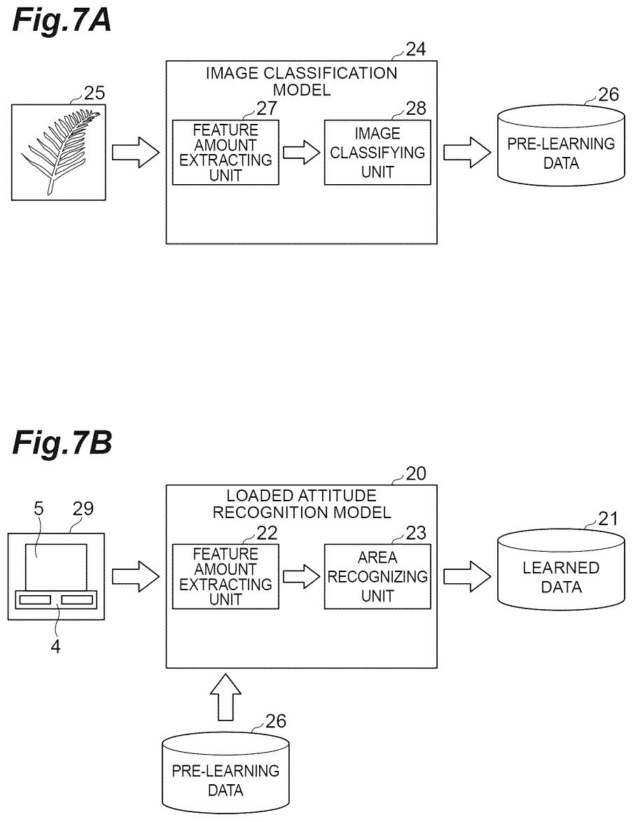

As illustrated in FIGS. 7A and 7B, the learned data 21 is generated by pre-learning a formula driven database. The formula driven database is an image generated from a mathematical formula, and is data whose label does not need to be assigned to an image. As the formula driven database, for example, a data set (Fractal DB) including fractal geometric images, or the like is used.

More specifically, first, as illustrated in FIG. 7A, an image classification model 24 pre-learns a formula driven database 25 to create pre-learning data 26. Mathematical formula driven supervised learning is used as pre-learning of the formula driven database 25. The image classification model 24 includes a feature amount extracting unit 27 that extracts a feature amount of the formula driven database 25, and an image classifying unit 28 that solves an image classification problem of the feature amount of the formula driven database 25.

Further, as illustrated in FIG. 7B, the transfer learning is performed using the pre-learning data 26, and the above loaded attitude recognition model 20 is constructed to create the learned data 21. At this time, the feature amount extracting unit 22 is caused to read the pre-learning data 26 obtained by pre-learning the formula driven database 25, and performs transfer learning on the data obtained by assigning the areas of the front surface 4a of the pallet 4 and the front surface 5a of the cargo to a loaded attitude image 29 obtained by photographing the pallets 4 and the cargos 5 to acquire the learned data 21.

Returning to FIG. 1, the loaded attitude abnormality determining unit 16 includes a pallet interference determining unit 16a, a cargo interference determining unit 16b, and a protrusion determining unit 16c.

The pallet interference determining unit 16a determines whether or not the detection target pallet 4 interferes with the pallet 4 neighboring in the lateral direction based on the areas of the front surface 4a of the pallet 4 and the front surface 5a of the cargo 5 in the loaded attitude image data extracted by the area extracting unit 15.

The cargo interference determining unit 16b determines whether or not the detection target cargo 5 interferes with the cargo 5 or the pallet 4 neighboring in the lateral direction based on the areas of the front surface 4a of the pallet 4 and the front surface 5a of the cargo 5 in the loaded attitude image data extracted by the area extracting unit 15.

The protrusion determining unit 16c determines whether or not the cargo 5 disposed on the holding target pallet 4 held by the forks 36 of the forklift 2 or the other pallet 4 protrudes from the holding target pallet 4 by the prescribed amount or more in the lateral direction, based on the areas of the front surface 4a of the pallet 4 and the front surface 5a of the cargo 5 extracted by the area extracting unit 15. The holding target pallet 4 is the pallet 4 into which the forks 36 are to be inserted.

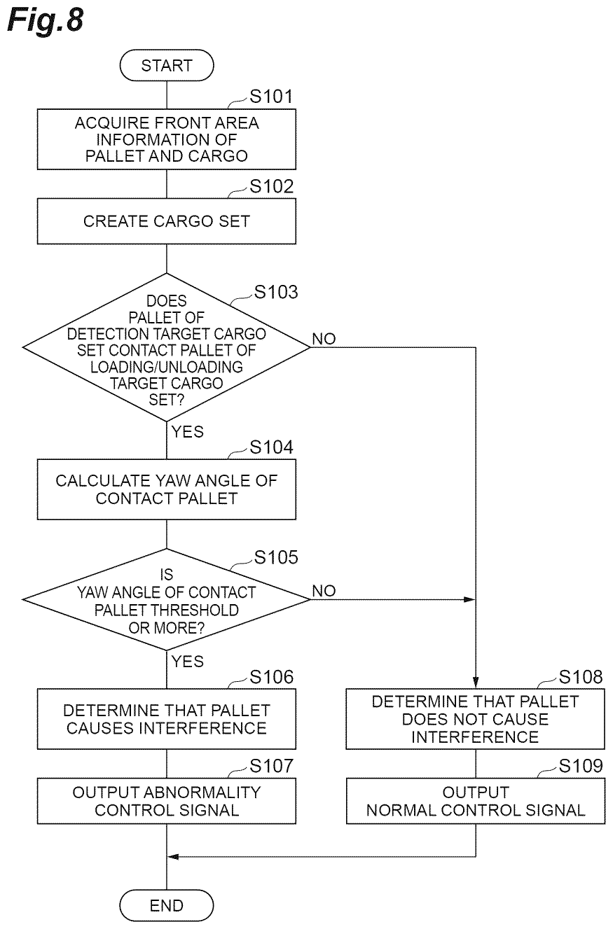

FIG. 8 is a flowchart illustrating a procedure of pallet interference determination processing executed by the pallet interference determining unit 16a. This processing is executed when, for example, a manual operation switch or the like instructs start of the loading/unloading control.

In FIG. 8, the pallet interference determining unit 16a first acquires area information of the front surface 4a of the pallet 4 and the front surface 5a of the cargo 5 (front area information of the pallet 4 and the cargo 5) in the loaded attitude image data extracted by the area extracting unit 15 (procedure S101).

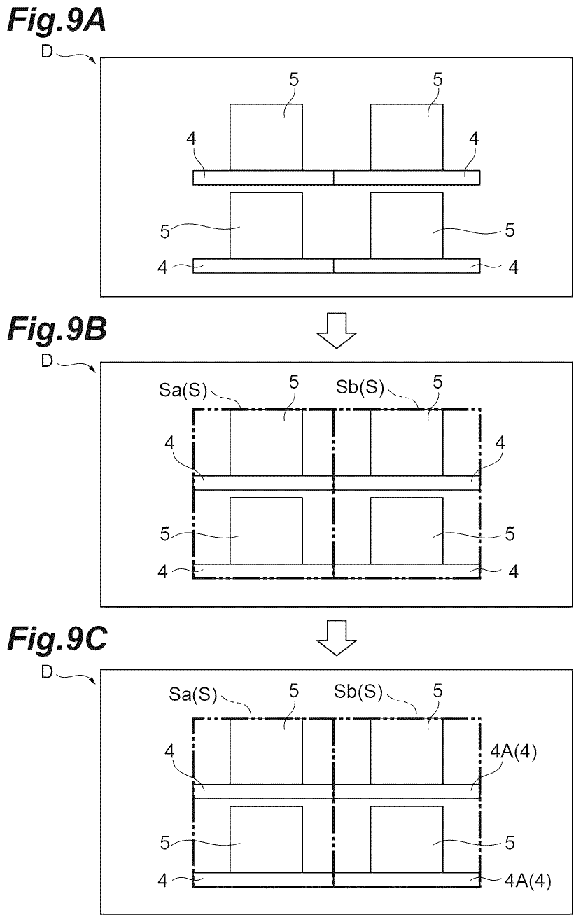

Subsequently, the pallet interference determining unit 16a creates a plurality sets of the cargo sets S in the front areas of the pallets 4 and the cargos 5 in the loaded attitude image data (procedure S102). FIG. 9A illustrates an example of the front areas of the pallets 4 and the cargos in the loaded attitude image data D extracted by the area extracting unit 15.

As illustrated in FIG. 9B, the cargo set S indicates a quadrangular area including the pallets 4 and the cargos 5 in contact with each other in an upper-lower direction in the loaded attitude image data D. That is, the cargo set S indicates the area including only the pallets 4 and the cargos 5 in contact with each other in the upper-lower direction in the loaded attitude image data D, and does not include the pallets 4 and the cargos 5 neighboring in the left-right direction (lateral direction). A plurality of sets of the cargo sets S are created along the lateral direction in the loaded attitude image data D. In the loaded attitude image data D illustrated in FIG. 9B, two sets of the cargo sets Sa and Sb neighboring in the lateral direction are created. The cargo sets Sa and Sb include the pallets 4 and the cargos 5 of the two upper and lower stages.

Subsequently, the pallet interference determining unit 16a determines whether or not the pallet 4 of the detection target cargo set S among the plurality of sets of cargo sets S contacts the pallet 4 of the loading/unloading target cargo set S neighboring in the lateral direction (procedure S103). The pallet interference determining unit 16a determines whether or not pixels of the pallet 4 of the detection target cargo set S contact pixels of the pallet 4 of the loading/unloading target cargo set S in the loaded attitude image data D, and thereby determines whether or not the pallet 4 of the detection target cargo set S contacts the pallet 4 of the loading/unloading target cargo set S. The loading/unloading target cargo set S is the cargo set S including the pallet 4 and the cargo 5 to be loaded and unloaded next.

In FIG. 9B, the cargo set Sa is the loading/unloading target cargo set S, and the cargo set Sb is the detection target cargo set S. Therefore, whether or not the pallet 4 of the detection target cargo set Sb contacts the pallet 4 of the loading/unloading target cargo set Sa is determined.

When determining that the pallet 4 of the detection target cargo set S contacts the pallet 4 of the loading/unloading target cargo set S neighboring in the lateral direction, the pallet interference determining unit 16a calculates a yaw angle that is an attitude angle of the pallet 4 (hereinafter, referred to as a contact pallet 4A) of the detection target cargo set S based on the area information of the pallet 4 in the loaded attitude image data D and shape information of the pallet 4 that is known in advance (procedure S104).

In a state where the contact pallet 4A faces the front of the forklift 2, the yaw angle of the contact pallet 4A is 0 degree. In FIG. 9C, the pallet 4 of the detection target cargo set Sb is the contact pallet 4A in contact with the pallet 4 of the loading/unloading target cargo set Sa.

Then, the pallet interference determining unit 16a determines whether or not the yaw angle of the contact pallet 4A is a predetermined threshold or more (procedure S105). The threshold is set to an angle that does not influence an unloading operation of the pallet 4 and the cargo 5 of the loading/unloading target cargo set S even when the pallet 4 of the detection target cargo set S and the pallet 4 of the loading/unloading target cargo set S are in contact with each other, that is, to, for example, an angle that does not cause cargo collapse of the cargo 5.

When determining that the yaw angle of the contact pallet 4A is the threshold or more, the pallet interference determining unit 16a determines that the pallet 4 of the detection target cargo set S interferes with the pallet 4 of the loading/unloading target cargo set S (procedure S106). Then, the pallet interference determining unit 16a outputs an abnormality control signal to the loading/unloading controlling unit 17 (procedure S107).

When determining in procedure S103 that the pallet 4 of the detection target cargo set S does not contact the pallet 4 of the loading/unloading target cargo set S neighboring in the lateral direction, or when determining in procedure S105 that the yaw angle of the contact pallet 4A is not the threshold or more, the pallet interference determining unit 16a determines that the pallet 4 of the detection target cargo set S does not interfere with the pallet 4 of the loading/unloading target cargo set S (procedure S108). Then, the pallet interference determining unit 16a outputs a normal control signal to the loading/unloading controlling unit 17 (procedure S109).

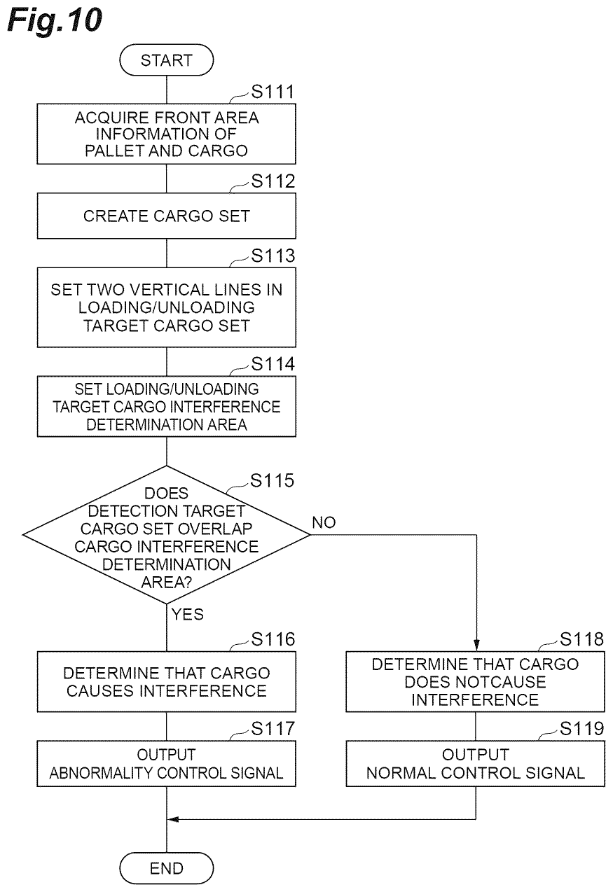

FIG. 10 is a flowchart illustrating a procedure of cargo interference determination processing executed by the cargo interference determining unit 16b. Similarly to the pallet interference determining unit 16a, this processing is also executed when the start of the loading/unloading control is instructed.

In FIG. 10, the cargo interference determining unit 16b first acquires area information of the front surface 4a of the pallet 4 and the front surface 5a of the cargo 5 (front area information of the pallet 4 and the cargo 5) in the loaded attitude image data extracted by the area extracting unit 15 (procedure S111).

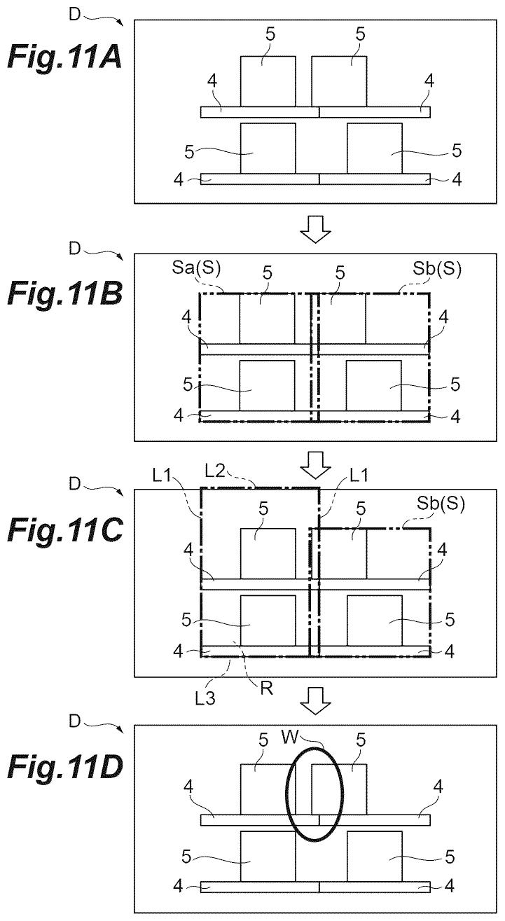

Subsequently, the cargo interference determining unit 16b creates a plurality sets of the cargo sets S in the front areas of the pallets 4 and the cargos 5 in the loaded attitude image data (procedure S112). FIG. 11A illustrates another example of the front areas of the pallets 4 and the cargos 5 in the loaded attitude image data D extracted by the area extracting unit 15.

Similarly to above procedure S102, as illustrated in FIG. 11B, the cargo set S indicates a quadrangular area including the pallets 4 and the cargos 5 in contact with each other in the upper-lower direction in the loaded attitude image data D. In the loaded attitude image data D illustrated in FIG. 11B, two sets of the cargo sets Sa and Sb neighboring in the lateral direction are created. The cargo sets Sa and Sb include the pallets 4 and the cargos 5 of the two upper and lower stages.

Subsequently, the cargo interference determining unit 16b sets, in the loaded attitude image data D, virtual lines L1 that are two vertical lines formed by extending in the upper-lower direction the left and right ends of the pallet 4 of the loading/unloading target cargo set S (procedure S113). At this time, in a case where positions of the left and right ends of the pallets 4 of the two upper and lower stages are shifted, the two virtual lines L1 formed by extending in the upper-lower direction the ends located outside the left-right direction among the left and right ends of the pallets 4 of the two upper and lower stages are set. In the loaded attitude image data D illustrated in FIG. 11C, two virtual lines L1 formed by extending in the upper-lower direction the left and right ends of the pallet 4 of the loading/unloading target cargo set Sa are set.

Subsequently, the cargo interference determining unit 16b sets a loading/unloading target cargo interference determination area R in the loaded attitude image data D (procedure S114). As illustrated in FIG. 11C, the loading/unloading target cargo interference determination area R is an area surrounded by the two virtual lines L1, a horizontal line L2 of an upper end of the loaded attitude image data D, and a horizontal line L3 which is a bottom surface of the lower pallet 4, in the loaded attitude image data D. The loading/unloading target cargo interference determination area R corresponds to an inner area of the two virtual lines L1.

Subsequently, the cargo interference determining unit 16b determines whether or not the detection target cargo set S overlaps the loading/unloading target cargo interference determination area R (procedure S115). When determining that the detection target cargo set S overlaps the loading/unloading target cargo interference determination area R, the cargo interference determining unit 16b determines that the cargo 5 of the detection target cargo set S interferes with the cargo 5 or the pallet 4 of the loading/unloading target cargo set S (procedure S116). Then, the cargo interference determining unit 16b outputs an abnormality control signal to the loading/unloading controlling unit 17 (procedure S117).

In the loaded attitude image data D illustrated in FIG. 11C, part of the detection target cargo set Sb overlaps the loading/unloading target cargo interference determination area R. Hence, as illustrated in FIG. 11D, it is determined that the cargo 5 of the detection target cargo set Sb interferes with the cargo 5 or the pallet 4 of the loading/unloading target cargo set Sa (see W in FIG. 11D).

When determining that the detection target cargo set S does not overlap the loading/unloading target cargo interference determination area R, the cargo interference determining unit 16b determines that the cargo 5 of the detection target cargo set S does not interfere with the cargo and the pallet 4 of the loading/unloading target cargo set S (procedure S118). Then, the cargo interference determining unit 16b outputs a normal control signal to the loading/unloading controlling unit 17 (procedure S119).

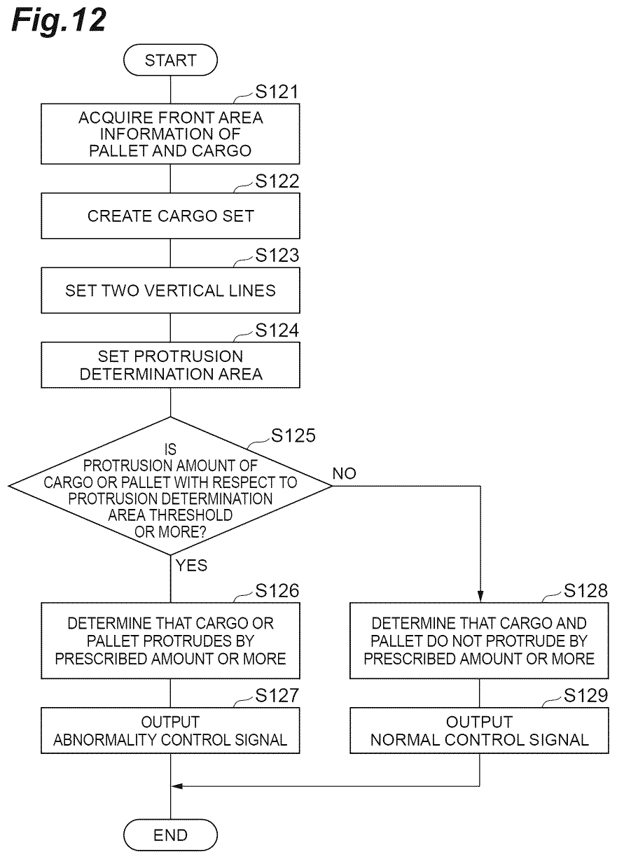

FIG. 12 is a flowchart illustrating a procedure of protrusion determination processing executed by the protrusion determining unit 16c. Similarly to the pallet interference determining unit 16a, this processing is also executed when the start of the loading/unloading control is instructed.

In FIG. 12, the protrusion determining unit 16c first acquires area information of the front surface 4a of the pallet 4 and the front surface 5a of the cargo 5 (front area information of the pallet 4 and the cargo 5) in the loaded attitude image data extracted by the area extracting unit 15 (procedure S121).

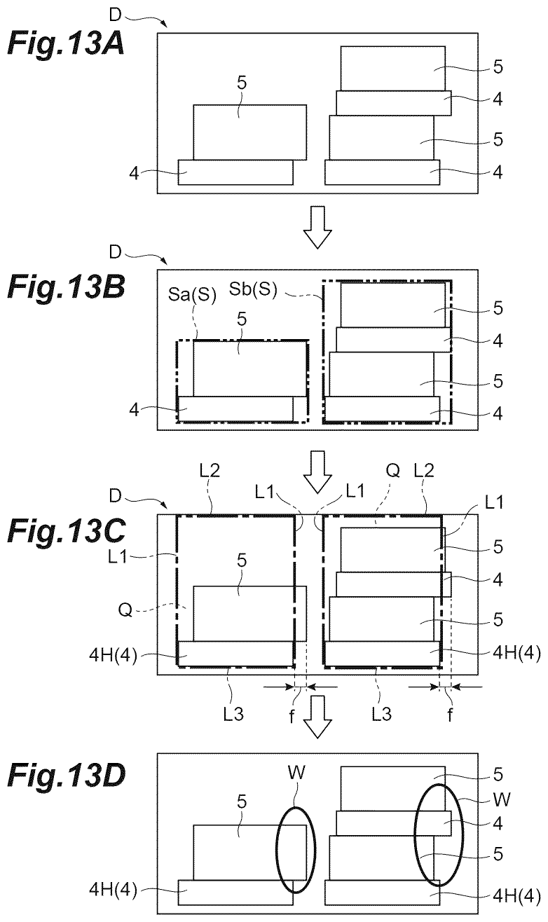

Subsequently, the protrusion determining unit 16c creates a plurality sets of the cargo sets S in the front areas of the pallets 4 and the cargos 5 in the loaded attitude image data (procedure S122). FIG. 13A illustrates still another example of the front areas of the pallets 4 and the cargos 5 in the loaded attitude image data D extracted by the area extracting unit 15.

Similarly to above procedure S102, as illustrated in FIG. 13B, the cargo set S indicates a quadrangular area including the pallets 4 and the cargos 5 in contact with each other in the upper-lower direction in the loaded attitude image data D. In the loaded attitude image data D illustrated in FIG. 13B, two sets of the cargo sets Sa and Sb neighboring in the lateral direction are created. The cargo set Sa includes the pallet 4 and the cargo 5 of one stage. The cargo set Sb includes the pallets 4 and the cargos 5 of the two upper and lower stages.

Subsequently, the protrusion determining unit 16c sets the virtual lines L1 that are two vertical lines formed by extending in the upper-lower direction the left and right ends of the holding target pallet 4 (hereinafter, referred to as a holding pallet 4H) of each cargo set S in the loaded attitude image data D (procedure S123). The holding pallet 4H is the pallet 4 held by the forks 36 of the forklift 2 as described above. At this time, in a case where there are the pallets 4 of two or more upper and lower stages, the lowermost pallet 4 is the holding pallet 4H.

In the loaded attitude image data D illustrated in FIG. 13C, two virtual lines L1 formed by extending in the upper-lower direction the left and right ends of the pallet 4 of the cargo set Sa and two virtual lines L1 formed by extending in the upper-lower direction the left and right ends of the lower pallet 4 of the cargo set Sb are set.

Subsequently, the protrusion determining unit 16c sets a protrusion determination area Q of each cargo set S in the loaded attitude image data D (procedure S124). As illustrated in FIG. 13C, the protrusion determination area Q is an area surrounded by two virtual lines L1, a horizontal line L2 of an upper end of the loaded attitude image data D, and a horizontal line L3 which is a bottom surface of the lower pallet 4, in the loaded attitude image data D. The protrusion determination area Q corresponds to the inner area of the two virtual lines L1.

Subsequently, the protrusion determining unit 16c determines whether or not a protrusion amount f of the cargo 5 or the pallet 4 with respect to the protrusion determination area Q is a predetermined threshold or more in each cargo set S (procedure S125). The threshold is set to a value that does not influence an unloading operation of the pallet 4 and the cargo 5 even when the cargo 5 or the pallet 4 protrudes from the protrusion determination area Q in the lateral direction, that is, to, for example, a value that does not cause cargo collapse of the cargo 5.

When it is determined that the protrusion amount f of the cargo 5 or the pallet 4 with respect to the protrusion determination area Q is the threshold or more, the protrusion determining unit 16c determines that the cargo 5 or the other pallet 4 protrudes from the holding pallet 4H by the prescribed amount or more in the lateral direction (procedure S126). Then, the protrusion determining unit 16c outputs an abnormality control signal to the loading/unloading controlling unit 17 (procedure S127).

In the loaded attitude image data D illustrated in FIG. 13C, the protrusion amount f of the cargo 5 with respect to the protrusion determination area Q in the cargo set Sa is the threshold or more, and the protrusion amount f of the pallet 4 with respect to the protrusion determination area Q in the cargo set Sb is the threshold or more. Therefore, as illustrated in FIG. 13D, it is determined that the cargo 5 protrudes from the holding pallet 4H in the cargo set Sa by the prescribed amount or more in the lateral direction, and it is determined that the upper pallet 4 protrudes from the lower pallet 4, which is the holding pallet 4H, in the cargo set Sb by the prescribed amount or more in the lateral direction (see W in FIG. 13D).

When it is determined that the protrusion amount f of the cargo 5 and the pallet 4 with respect to the protrusion determination area Q is the threshold or more, the protrusion determining unit 16c determines that the cargo 5 and the other pallet 4 do not protrude from the holding pallet 4H by the prescribed amount or more in the lateral direction (procedure S128). Then, the protrusion determining unit 16c outputs a normal control signal to the loading/unloading controlling unit 17 (procedure S129).

Returning to FIG. 1, the loading/unloading controlling unit 17 controls the driving unit 12 and the warning unit 13 according to a determination result of the loaded attitude abnormality determining unit 16. When receiving an input of the normal control signal from all of the pallet interference determining unit 16a, the cargo interference determining unit 16b, and the protrusion determining unit 16c, the loading/unloading controlling unit 17 controls the driving unit 12 to unload a loading/unloading target. When receiving an input of the abnormality control signal from any of the pallet interference determining unit 16a, the cargo interference determining unit 16b, and the protrusion determining unit 16c, the loading/unloading controlling unit 17 controls the warning unit 13 to issue a warning.

As described above, in a case where the forklift 2 performs unloading, the forklift 2 travels toward the truck 3. Further, when the forklift 2 reaches the side of the truck 3, the forklift 2 temporarily stops. When the camera 11 images the loaded attitude state where the cargos 5 are placed on the plurality of pallets 4 in this state, the loaded attitude image data D of the pallets 4 and the cargos 5 is acquired.

Further, the front areas of the pallets 4 and the cargos 5 in the loaded attitude image data D are extracted. Further, whether or not the pallet 4 of the detection target cargo set S interferes with the pallet 4 of the loading/unloading target cargo set S neighboring in the lateral direction is determined based on the front areas of the pallets 4 and the cargos 5 in the loaded attitude image data D. Furthermore, whether or not the cargo 5 of the detection target cargo set S interferes with the cargo or the pallet 4 of the loading/unloading target cargo set S is determined based on the front areas of the pallets 4 and the cargos 5 in the loaded attitude image data D. Further, based on the front areas of the pallets 4 and the cargos 5 in the loaded attitude image data D, it is determined whether or not the cargo 5 disposed on the holding pallet 4H or the other pallet 4 protrudes from the holding pallet 4H by the prescribed amount or more in the lateral direction.

When it is determined that the pallet 4 of the detection target cargo set S does not interfere with the pallet 4 of the loading/unloading target cargo set S, when it is determined that the cargo 5 of the detection target cargo set S does not interfere with the cargo 5 or the pallet 4 of the loading/unloading target cargo set S, and when it is determined that the cargo 5 disposed on the holding pallet 4H and the other pallet 4 do not protrude from the holding pallet 4H by the prescribed amount or more in the lateral direction, the driving unit 12 is controlled to unload the loading/unloading target cargo set S.

When it is determined that the pallet 4 of the detection target cargo set S interferes with the pallet 4 of the loading/unloading target cargo set S, the warning unit 13 issues a warning, and unloading of the detection target cargo set S is stopped. When it is determined that the cargo 5 of the detection target cargo set S interferes with the cargo 5 or the pallet 4 of the loading/unloading target cargo set S, the warning unit 13 also issues a warning, and unloading of the detection target cargo set S is stopped. Even when it is determined that the cargo 5 disposed on the holding pallet 4H or the other pallet 4 protrudes from the holding pallet 4H by the prescribed amount or more in the lateral direction, the warning unit 13 issues a warning, and the unloading of the detection target cargo set S is stopped.

As described above, in the present embodiment, the areas of the pallets 4 and the cargos 5 are extracted in the loaded attitude image data D acquired by detecting the loaded attitudes of the pallets 4 and the cargos 5. Further, based on the areas of the pallets 4 and the cargos 5 in the loaded attitude image data D, it is determined whether or not the cargo 5 disposed on the holding target pallet 4 (holding pallet 4H) held by the forklift 2 or the other pallet 4 protrudes from the holding pallet 4H by the prescribed amount or more in the lateral direction. When it is determined that the cargo 5 disposed on the holding pallet 4H or the other pallet 4 protrudes from the holding pallet 4H by the prescribed amount or more in the lateral direction, it is detected that the loaded attitude states of the pallets 4 and the cargos 5 are abnormal. Consequently, it is possible to detect whether or not the loaded attitude states of the pallets 4 and the cargos 5 are abnormal. As a result, it is possible to achieve appropriate loading/unloading control matching the loaded attitude states of the pallets 4 and the cargos 5.

Furthermore, in the present embodiment, the front areas of the pallets 4 and the cargos 5 in the loaded attitude image data D are extracted. Hence, the influence of the shadow or the like of lateral areas of the pallets 4 and the cargos 5 on the protrusion determination of the cargos 5 and the pallets 4 in the loaded attitude image data D is suppressed. Consequently, it is accurately determined whether or not the cargo 5 disposed on the holding pallet 4H or the other pallet 4 protrudes from the holding pallet 4H by the prescribed amount or more in the lateral direction.

Furthermore, in the present embodiment, the cargo set S indication an area including the pallets 4 and the cargos 5 in contact with each other in the upper-lower direction in the loaded attitude image data D is created, and it is determined whether or not the protrusion amount of the cargo 5 or the other pallet 4 with respect to the inner area of the two virtual lines L1 formed by extending in the upper-lower direction left and right ends of the holding pallet 4H in the cargo set S is a threshold or more. Therefore, whether or not the cargo 5 and the pallet 4 protrude is determined per cargo set S. The cargo set S corresponds to a unit of loading/unloading collectively performed by the forklift 2. Consequently, it is possible to efficiently determine whether or not the cargo 5 and the pallet 4 protrude in units of loading/unloading. Furthermore, by setting the inner area of the two virtual lines L1 formed by extending in the upper-lower direction left and right ends of the holding pallet 4H in the cargo set S, it is possible to easily determine whether or not the cargo 5 or the other pallet 4 protrudes from the holding pallet 4H by the prescribed amount or more in the lateral direction. Furthermore, in the present embodiment, the loaded attitude image data D of the pallets 4 and the cargos 5 is acquired by imaging the loaded attitudes of the pallet 4 and the cargo 5, and the areas of the pallets 4 and the cargos 5 in the loaded attitude image data D are extracted in units of pixels of the loaded attitude image data D. By extracting the areas of the pallets 4 and the cargos 5 in units of pixels of the loaded attitude image data D in this way, it is possible to accurately extract the areas of the pallets 4 and the cargos 5 in the loaded attitude image data D.

Furthermore, in the present embodiment, using the learned data 21 including the loaded attitude images of a plurality of types of the pallets 4 and the cargos 5 and the pixel information of the plurality of types of the pallets 4 and the cargos 5, the areas of the pallets 4 and the cargos 5 in the loaded attitude image data D are extracted. By using the learned data 21 including the loaded attitude image and the pixel information in this way, it is possible to more accurately extract the areas of the pallets 4 and the cargos 5 in the loaded attitude image data D.

Furthermore, in the present embodiment, using the pre-learning data 26 obtained by pre-learning the formula driven database, the learned data 21 is generated by performing transfer learning on data obtained by annotating the pixel information of the pallets 4 and the cargos 5 to the loaded attitude images of the pallets 4 and the cargos 5. By using the pre-learning data 26 obtained by pre-learning the formula driven database in this way, it is possible to accurately extract the areas of the pallets 4 and the cargos 5 in the loaded attitude image data D while reducing the number of loaded attitude images obtained by imaging the loaded attitudes of the pallets 4 and the cargos 5.

Furthermore, in the present embodiment, by constructing the loaded attitude recognition model 20 by the instance segmentation model using deep learning, it is possible to more accurately extract the areas of the pallets 4 and the cargos 5 in the loaded attitude image data D.

Note that the present invention is not limited to the above embodiment. For example, in the above embodiment, the front areas of the pallets 4 and the cargos 5 in the loaded attitude image data D are extracted, and based on the front areas of the pallets 4 and the cargos 5, it is determined whether or not the cargo 5 disposed on the holding pallet 4H or the other pallet 4 protrudes from the holding pallet 4H by the prescribed amount or more in the lateral direction; however, the present invention is not particularly limited to such an embodiment. For example, areas including front, lateral, bottom surface, and the like of the pallets 4 and the cargos 5 in the loaded attitude image data D are extracted, and based on the areas of the pallets 4 and the cargos 5, it may be determined that whether or not the cargo 5 disposed on the holding pallet 4H or the other pallet 4 protrudes from the holding pallet 4H by the prescribed amount or more in the lateral direction.

Furthermore, in the above embodiment, it is determined whether or not the protrusion amount of the cargo 5 or the other pallet 4 with respect to the protrusion determination area Q, which is surrounded by the two virtual lines L1 formed by extending in the upper-lower direction left and right ends of the holding pallet 4H, the horizontal line L2 of the upper end of the loaded attitude image data D, and the horizontal line L3 which is the bottom surface of the holding pallet 4H, is the threshold or more; however, the present invention is not particularly limited to such an embodiment. For example, without using the horizontal line L2 of the upper end of the loaded attitude image data D and the horizontal line L3 which is the bottom surface of the holding pallet 4H, it may be determined whether or not the protrusion amount of the cargo 5 or the other pallet 4 with respect to the inner area of the of the two virtual lines L1 formed by extending in the upper-lower direction left and right ends of the holding pallet 4H is the threshold or more.

Furthermore, in the above embodiment, the learned data 21 is created using the pre-learning data 26 obtained by pre-learning the formula driven database. However, the learned data 21 may be created by increasing the number of the loaded attitude images of the pallets 4 and the cargos 5 without using the pre-learning data 26 in particular.

Furthermore, in the above embodiment, the camera 11 acquires the loaded attitude image data D of the pallets 4 and the cargos 5 by imaging the loaded attitude state where the cargos 5 are placed on the pallets 4. However, the present disclosure is not particularly limited to this embodiment. The loaded attitude detection data of the pallets 4 and the cargos 5 may be acquired by detecting the loaded attitude state where the cargos 5 are placed on the pallets 4 using a laser sensor or the like.

Furthermore, in the above embodiment, when the forklift 2 unloads the pallet 4 loaded on the bed 3a of the truck 3, the loaded attitude states of the pallet 4 and the cargo 5 is detected. However, the present invention is not particularly limited to the bed 3a of the truck 3, and is also applicable to, for example, a case where the pallets 4 loaded on a floor surface or the like in a factory are unloaded.

### REFERENCE SIGNS LIST

2 Forklift
4 Pallet
4H Holding pallet (holding target pallet)
4a Front surface (front)
5 Cargo
5a Front surface (front)
10 Loaded attitude state detecting device
11 Camera (detecting unit)
15 Area extracting unit
16a Protrusion determining unit
21 Learned data
25 Formula driven database
26 Pre-learning data
29 Loaded attitude image
D Loaded attitude image data (loaded attitude detection data)
S Cargo set
Sa, Sb Cargo set
L1 Virtual line
Q Protrusion determination area (inner area)

What is claimed is:

1. A loaded attitude state detecting device configured to detect loaded attitude states of pallets and cargos when a forklift performs loading/unloading of at least one stage of the pallets with cargos placed thereon, the loaded attitude state detecting device comprising:
a detecting unit configured to acquire loaded attitude detection data of the pallets and the cargos by detecting loaded attitudes of the pallets and the cargos;
an area extracting unit configured to extract areas of the pallets and the cargos in the loaded attitude detection data acquired by the detecting unit; and
a protrusion determining unit configured to determine whether or not a cargo disposed on a holding target pallet held by the forklift or another pallet protrudes from the holding target pallet by a prescribed amount or more in a lateral direction based on the areas of the pallets and the cargos.

2. The loaded attitude state detecting device according to claim 1, wherein the area extracting unit extracts front areas of the pallets and the cargos in the loaded attitude detection data.

3. The loaded attitude state detecting device according to claim 1, wherein the protrusion determining unit determines whether or not the cargo or the another pallet protrudes from the holding target pallet by the prescribed amount or more in the lateral direction by creating a cargo set indicating an area including the pallets and the cargos in contact with each other in an upper-lower direction in the loaded attitude detection data, and determining whether or not a protrusion amount of the cargo or the another pallet with respect to an inner area of two virtual lines formed by extending in the upper-lower direction left and right ends of the holding target pallet in the cargo set is a predetermined threshold or more.

4. The loaded attitude state detecting device according to claim 1, wherein
the detecting unit acquires a loaded attitude image data of the pallets and the cargos as the loaded attitude detection data by imaging the loaded attitudes of the pallets and the cargos, and
the area extracting unit extracts the areas of the pallets and the cargos in the loaded attitude image data in units of pixels of the loaded attitude image data.

5. The loaded attitude state detecting device according to claim 4, wherein the area extracting unit extracts the areas of the pallets and the cargos in the loaded attitude image data by using learned data including loaded attitude images of a plurality of types of pallets and cargos and pixel information of the plurality of types of the pallets and the cargos.

6. The loaded attitude state detecting device according to claim 5, wherein the learned data is generated by performing transfer learning on data obtained by annotating the pixel information of the pallets and the cargos to the loaded attitude images of the pallets and the cargos, using pre-learning data obtained by pre-learning a formula driven database.
